(19) United States
(12) Patent Application Publication
(10) Pub. No.: US 2007/0040832 A1
(43) Pub. Date: Feb. 22, 2007

(54) Trapezoidal shadow maps

(76) Inventors: Tiow Seng Tan, Singapore (SG); Tobias Oskar Martin, Gottmadingen (DE)

Correspondence Address: CHRISTIE, PARKER & HALE, LLP, PO BOX 7068, PASADENA, CA, 91109-7068, US

(21) Appl. No.: 10/566,858

(22) PCT Filed: Jul. 30, 2004
(86) PCT No.: PCT/SG04/00230

§ 371 Date: Oct. 5, 2006

Related U.S. Application Data
(60) Provisional application No. 60/491,368, filed on Jul. 31, 2003.
(60) Provisional application No. 60/581,978, filed on Jun. 21, 2004.

(51) Int. Cl. G06T 15/50

(52) U.S. Cl. 345/426

(57) ABSTRACT

A method of real-time shadow generation in computer graphical representation of a scene, the method comprising defining an eye's frustum based on a desired view of the scene; defining a location of a light source illuminating at least a portion of the scene; generating a trapezoid to approximate an area, E, within the eye's frustum in the post-perspective space of the light, L; applying a trapezoidal transformation to objects within the trapezoid into a trapezoidal space for computing a shadow map; and determining whether an object or part thereof is in shadow in the desired view of the scene utilising the computed shadow map.

### FIELD OF THE INVENTION

The present invention relates broadly to a method of deriving a shadow map for real-time shadow generation in computer graphical representation of a scene, a data storage medium and a computer system.

### BACKGROUND

Real-time shadow generation in computer graphics systems is gaining much attention recently due to the growing processing supports by powerful graphic processing units. In many applications, shadows are important because they add further realism to scenes and provide additional depth cues.

Finding ways on how to calculate shadows started a few decades ago. We note that in most of the techniques there is a trade off between shadow quality and rendering time. Recent approaches are based on the standard shadow map algorithm (SSM). This two-pass algorithm is neat and easy to understand. In the first pass, the scene is rendered from the viewpoint of the light with depth buffer enabled. This buffer is read or stored into an image called shadow map. In the second pass, the scene is rendered from the camera viewpoint incorporating shadow determination for each fragment. A fragment is in shadow if its z-value when transformed into the light's view is greater than its corresponding depth value stored in the shadow map.

The standard shadow map algorithm is easy to implement and is also fast in its calculation compared to other approaches. Additionally, its operations can be mapped and be executed efficiently in recent graphics hardware. A special texture is used for the shadow map and the shadow determination is performed with projective texture mapping.

On the other hand, SSM has a number of limitations. The first drawback is a resolution problem. The SSM works well when the light is close to the scene and to the viewpoint of the eye, but produces aliases around shadow boundaries when the light is far away. This is caused by low shadow map resolution in areas where a higher resolution is needed. Besides the practical scenario where only a small amount of texture memory is used to capture shadow map, this problem can arise as the focus region of the eye's frustum contributes a very small fraction to the shadow map—whereas the remaining space in the shadow map that corresponds to those locations invisible to the eye's view is not utilised.

Another limitation is referred to as polygon offset problem. Due to the image space property, shadow comparisons are performed with finite precision which causes the problem of self-shadowing. This can be addressed by finding a bias (and a slope factor) which is added to the depth values of the shadow map to move the z-values slightly away from the light. We note that some approaches solve the resolution problem at the cost of worsening the polygon offset problem using a non-linear distribution of the depth values.

Another limitation is referred to as a continuity problem where the shadow map quality changes significantly from frame to frame resulting in the flickering of shadows. This occurs in all modified shadow map approaches such as the bounding box approximation approach (see FIG. 2) and the perspective shadow maps. Specifically, for example, perspective shadow maps rely on the convex hull of all objects that can cast shadows. This convex hull and the resulting shadow quality can change suddenly. In one case, this occurs when objects move into or out of the light's frustum in a dynamic environment. In another case, it can be observed when the algorithm virtually moves the position of the eye to avoid, for example, the inverted order of objects due to the perspective projection.

Hence, it was with a view to balancing the above mentioned limitations that the present invention was conceived and has now been reduced to practice.

### SUMMARY

In accordance with a first aspect of the present invention there is provided a method of real-time shadow generation in computer graphical representation of a scene, the method comprising defining an eye's frustum based on a desired view of the scene; defining a location of a light source illuminating at least a portion of the scene; generating a trapezoid to approximate an area, E, within the eye's frustum in the post-perspective space of the light, L; applying a trapezoidal transformation to objects within the trapezoid into a trapezoidal space for computing a shadow map; and determining whether an object or part thereof is in shadow in the desired view of the scene utilising the computed shadow map.

Generating the top and base lines Iₜ and 1_{b} respectively, of the trapezoid to approximate E in L, may comprise
computing a centre line I, which passes through centres of the near and far planes of E;
calculating the 2D convex hull of E;
calculating Iₜ that is orthogonal to I and touches the boundary of the convex hull of E;
calculating I_{b} which is parallel to Iₜ and touches the boundary of the convex hull of E.

In the case that the centres of the far and near planes of E are substantially coincident, a smallest box bounding the far plane may be defined as the trapezoid.

Generating the side lines of the trapezoid to approximate E in L may comprise
assigning a distance d from the near plane of the eye's frustum to define a focus region in the desired view of the scene;
determining a point p_{L} in L that lies on I at the distance d from the near plane of the eye's frustum;
computing the position of a point q on I, wherein q is the centre of a projection to map the base line and the top line of the trapezoid to y=−1 and y=+1 respectively, and to map p_{L} to a point on y=ξ, with ξ between −1 and +1; and
constructing two side lines of the trapezoid each passing through q, wherein each sideline touches the 2D convex hull of E on respective sides of I.

In one embodiment, ξ=−0.6.

The desired point ξ may be determined based on an iterative process that minimizes wastage.

The iterative process may be stopped when a local minimum is found.

The iterative process may be pre-computed and the results stored in a table for direct reference.

The method may comprise
determining an intersection I, between the light source's frustum and the eye's frustum;
computing the centre point e of the vertices of I;
defining a centre line Iₙ passing through the position of the eye and e, for generating the trapezoid.

The method may comprise defining a new focus region which lies between the near and far planes of the eye's frustum that are geometrically pushed closer to tightly bound I.

The trapezoidal transformation may comprise mapping the four corners of the trapezoid to a unit square that is the shape of a square shadow map, or to a general rectangle that is the shape of a rectangular shadow map.

The size of the square or general rectangle may change based on a configuration of the light source and the eye.

The trapezoidal transformation may transform only the x and the y values of a vertex from the post-perspective space of the light to the trapezoidal space, while the z value is maintained at the value in the post-perspective space of the light.

The method may comprise applying the trapezoidal transformation to obtain the x, y, and w values in the trapezoidal space, x_{T}, y_{T}, and w_{T}, and computing the z value in the trapezoidal space, z_{T}, as

$${z}_{T} = \frac{{z}_{L} \cdot {w}_{T}}{{w}_{L}} . ,$$

where z_{L} and w_{L}, are the z and w values in the post-perspective space of the light, respectively.

The method may comprise:
in a first pass of shadow map generation,
   transforming coordinate values of a fragment from the trapezoidal space back into the post-perspective space L of the light to obtain a first transformed fragment, utilising the plane equation of the first transformed fragment to compute a distance value of the first transformed fragment from the light source in L, z_{L1}, adding an offset value to z_{L1}, and store the resulting value as a depth value in the shadow map;
in a second pass of shadow determination,
   transforming texture coordinate assigned, through projective texturing, to the fragment from the trapezoidal space back into L, obtaining a second transformed fragment from the transformed texture coordinate, utilising the plane equation of the second transformed fragment to compute a distance value of the second transformed fragment from the light source in L, z_{L2}, and determine whether the fragment is in shadow based on a comparison of the stored depth value in the shadow map and z_{L2}.

The method may comprise
in a first pass of shadow map generation,
   during a vertex stage, transforming coordinate values of the vertex into the trapezoidal space, and assigning to the vertex the texture coordinate equal to the vertex's coordinate values in the post-perspective space of the light, and
   during a fragment stage, replacing the depth of the fragment with the texture coordinate of the fragment, adding to the depth an offset, and store the resulting value as a depth value in the shadow map;
in a second pass of shadow determination,
   during the vertex stage, transforming coordinate values of the vertex into the post-perspective space of the eye, and assigning to the vertex two texture coordinates that are first the coordinate values of the vertex in the post-perspective space of the light and second the coordinate values of the vertex in the trapezoidal space, and
   during the fragment stage, determining shadow of the fragment based on a comparison of the stored depth value in the shadow map, as indexed based on the second texture coordinate of the fragment, with a value based on the first texture coordinate of the fragment.

The method may comprise:
in a first pass of shadow map generation,
   transforming coordinate values of a fragment from the trapezoidal space back into the post-perspective space L of the light to obtain a first transformed fragment, utilising the plane equation of the first transformed fragment to compute a distance value of the first transformed fragment from the light source in L, z_{L1}, adding an offset value to z_{L1}, and store the resulting value as a depth value in the shadow map,
in a second pass of shadow determination,
   during the vertex stage, transforming coordinate values of the vertex into the post-perspective space of the eye, and assigning to the vertex two texture coordinates that are first the coordinate values of the vertex in the post-perspective space of the light and second the coordinate values of the vertex in the trapezoidal space, and
   during the fragment stage, determining shadow of the fragment based on a comparison of the stored depth value in the shadow map, as indexed based on the second texture coordinate of the fragment, with a value based on the first texture coordinate of the fragment.

The method may comprise:
in a first pass of shadow map generation,
   during a vertex stage, transforming coordinate values of the vertex into the trapezoidal space, and assigning to the vertex the texture coordinate equal to the vertex's coordinate values in the post-perspective space of the light, and
   during a fragment stage, replacing the depth of the fragment with the texture coordinate of the fragment, adding to the depth an offset, and store the resulting value as a depth value in the shadow map;
in a second pass of shadow determination,
   transforming texture coordinate assigned, through projective texturing, to the fragment from the trapezoidal space back into L, obtaining a second transformed fragment from the transformed texture coordinate, ufilising the plane equation of the second transformed fragment to compute a distance value of the second transformed fragment from the light source in L, z_{L2}, and determine whether the fragment is in shadow based on a comparison of the stored depth value in the shadow map and z_{L2}.

The method may further comprise adding a polygon offset in the determining whether an object or part thereof is in shadow in the desired view of the scene for representation utilising the computed shadow map.

Two or more light sources may illuminate at least respective portions of the scene, and the method is applied for each light source.

In accordance with a second aspect of the present invention there is provided a system for real-time shadow generation in computer graphical representation of a scene, the system comprising a processor unit for defining an eye's frustum based on a desired view of the scene; for defining a location of a light source illuminating at least a portion of the scene; for generating a trapezoid to approximate an area, E, within the eye's frustum in the post-perspective space of the light, L, from the light source; for applying a trapezoidal transformation to objects within the trapezoid into a trapezoidal space, for computing a shadow map; and for determining whether an object or part thereof is in shadow in the desired view of the scene utilising the computed shadow map.

In accordance with a third aspect of the present invention there is provided a data storage medium having stored thereon computer code means for instructing a computer to execute a method of real-time shadow generation in computer graphical representation of a scene, the method comprising defining an eye's frustum based on a desired view of the scene; defining a location of a light source illuminating at least a portion of the scene; generating a trapezoid to approximate an area, E, within the eye's frustum in the post-perspective space of the light, L, from the light source; applying a trapezoidal transformation to objects within the trapezoid into a trapezoidal space for computing a shadow map; and determining whether an object or part thereof is in shadow in the desired view of the scene utilising the computed shadow map.

### BRIEF DESCRIPTION OF THE DRAWINGS

Embodiments of the invention will now be described, by way of example only, and in conjunction with the drawings, in which:

FIG. 1 illustrates a comparison between the shadows generated in the light's post-perspective space and in the trapezoidal space as described in an example embodiment.

FIG. 2 illustrates a comparison between the shadows generated in two consecutive frames by a bounding box approximation approach and a trapezoidal approximation approach as described in the example embodiment.

FIG. 3 illustrates a comparison between the shadow maps generated utilising the bounding box approximation approach and the trapezoidal approximation approach as described in the example embodiment.

FIG. 4 illustrates the trapezoidal transformation taking place in the trapezoidal approximation approach as described in the example embodiment.

FIG. 5 illustrates the trapezoidal transformation that maps focus region to within 80% of the shadow map as described in the example embodiment.

FIG. 6 shows the schematic diagram of the trapezoidal approximation approach as described in the example embodiment.

FIG. 7 shows a plot of the areas occupied by the focus regions in the shadow map with a constant up vector of the eye while varying the angle between the eye's and the light's line of sight.

FIG. 8 illustrates the quality of the shadows generated by the trapezoidal approximation approach as described in the example embodiment.

FIG. 9 is a schematic drawing of a computer system for implementing the method and system according to the example embodiment.

FIG. 10 illustrates the trapezoidal transformation and the four vertices of the trapezoid mapping the focus region to within 80% of the shadow map as described in the example embodiment.

FIG. 11 illustrates the step of transforming the centre of the top edge of the trapezoid to the origin during calculation of the trapezoidal transformation matrix as described in the example embodiment.

FIG. 12 illustrates the step of rotating the trapezoid during calculation of the trapezoidal transformation matrix as described in the example embodiment.

FIG. 13 illustrates the step of transforming the intersection of the two side lines containing the two side edges during calculation of the trapezoidal transformation matrix as described in the example embodiment.

FIG. 14 illustrates the step of shearing the trapezoid during calculation of the trapezoidal transformation matrix as described in the example embodiment.

FIG. 15 illustrates the step of scaling the trapezoid during calculation of the trapezoidal transformation matrix as described in the example embodiment.

FIG. 16 illustrates the step of transforming the trapezoid to a rectangle during calculation of the trapezoidal transformation matrix as described in the example embodiment.

FIG. 17 illustrates the step of translating the rectangle along the y-axis during calculation of the trapezoidal transformation matrix as described in the example embodiment.

FIG. 18 illustrates the step of scaling the rectangle during calculation of the trapezoidal transformation matrix as described in the example embodiment.

FIG. 19 illustrates the final result representative of the trapezoidal transformation matrix as described in the example embodiment.

### DETAILED DESCRIPTION

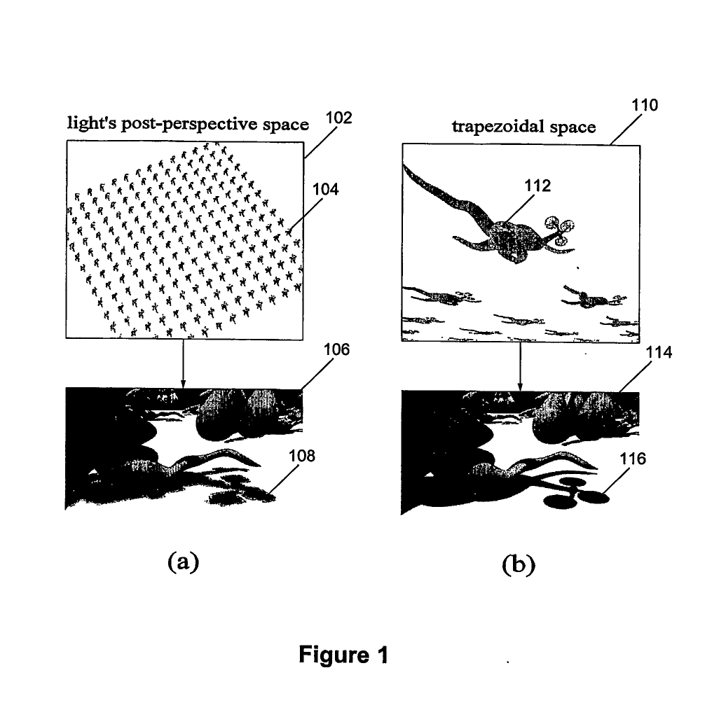

With reference to FIG. 1, an example embodiment of the present invention provides a method of calculating three Dimensional (3D) computer graphic shadows utilising trapezoidal shadow maps which are derived from trapezoidal approximations of the eye's frustums as seen from the light's view.

FIG. 1(a) shows the shadow map 102 of the scene 106 with 225 regularly spaced plant models 104 computed directly from the light's view or also known as the light's post-perspective space. As the light is far away, shadow aliasing appears in the view of the eye as shown in the shadow 108. FIG. 1(b) shows the shadow map 110 of the scene 114 computed from the light's view after applying trapezoidal transformation to focus on the region (of only 15 plant models 112) which is potentially visible to the eye. As a result, a high quality shadow 116 is obtained.

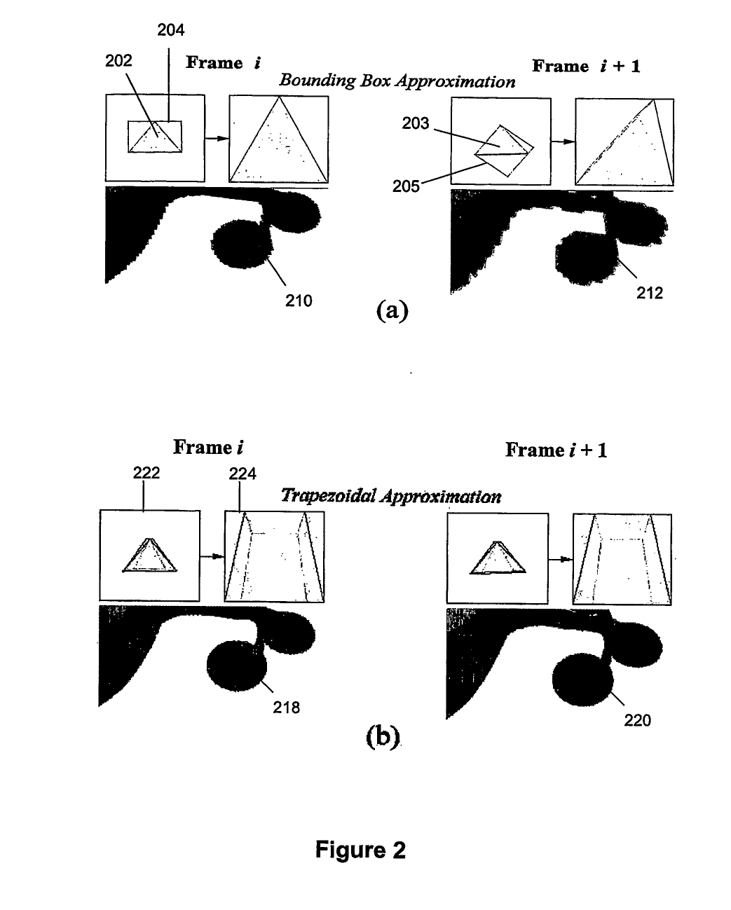

In addition, with reference to FIG. 2, the method of the example embodiment resolves shadow flickering caused by the continuity problem where the shadow quality changes drastically from frame to frame. In each of the four pictures, the post-perspective space of the light is on the top left e.g. 222, the generated shadow map on the top right e.g. 224, and the shadow of a plant 210, 212, 218 and 220 (as in the scene of FIG. 1) on the bottom. FIG. 2(a) shows the flickering of shadows (compare shadows 210, 212) from one frame i to the next frame i+1 generated by a standard bounding box approximation approach with the bounding box 204 of the area 202 within the eye's frustum as seen from the post-perspective space of a light source. The shadow quality of shadow 212 is significantly poorer as compared to that of shadow 210. In contrast, FIG. 2(b) shows a smooth shadow transition compare shadows 218, 220 from one frame i to the next frame i+1 generated with the use of a trapezoidal approximation approach as described in the example embodiment. There is not much difference in the quality of shadow 218 and shadow 220. Furthermore, it can again be seen that the quality of e.g. shadow 218 is improved compared to e.g. shadow 210.

Without loss of generality, the description assumes that there is a single light in the scene and the eye's frustum is completely within the light's frustum. In other words, there is a single light source that generates shadows. Other situations such as where the vertices of the eye's frustum lie behind or on the plane passing through the centre of the projection of the light and parallel to the near plane of the light will be discussed in the later part of the description.

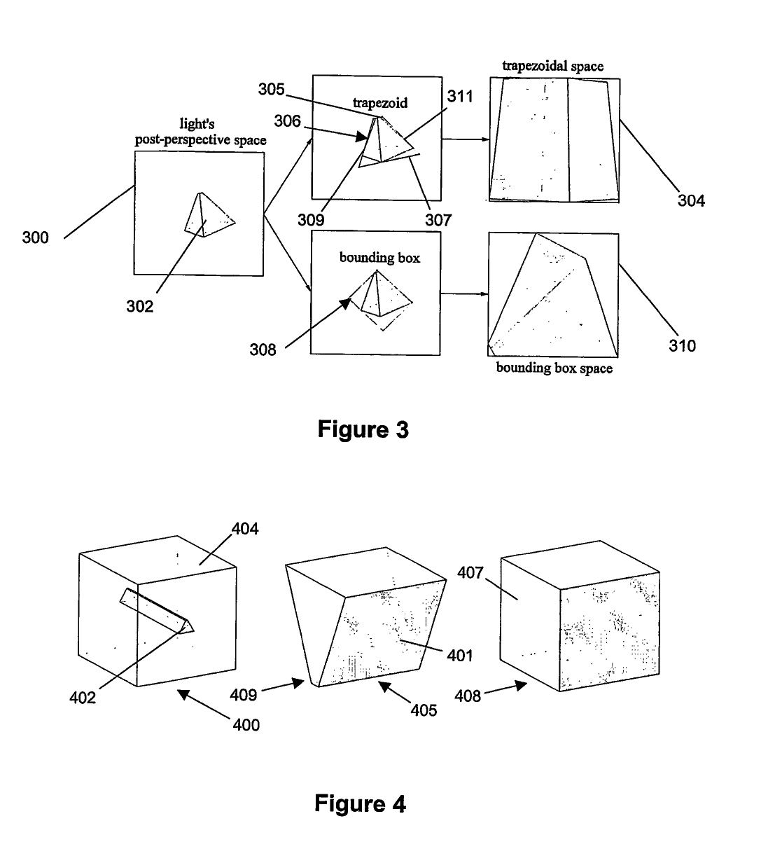

A shadow map can be viewed to consist of two portions: one within and the other outside the eye's frustum. It is recognised that only the former is useful in the determination of whether pixels are in shadow. Thus, to increase the shadow map resolution in one way is to minimise the entries occupied by the latter, collectively termed as wastage. FIG. 3 shows an example of the trapezoidal approximation 306 in the example embodiment and a smallest bounding box approximation 308 of the area 302 within the eye's frustum as seen from the light. One way to address the resolution problem is to better utilise the shadow map for the area 302 within the eye's frustum as seen from the light, herein referred to as E. This requires the calculation of an additional normalisation matrix N to transform the post-perspective space 300 of the light to an N-space, in general (where N-space, refers to the trapezoidal space 304 or the bounding box space 310) in FIG. 3. The shadow map is then constructed from the N-space, as opposed to from the post-perspective space 300. During shadow determination, a pixel is transformed into the N-space, rather than into the post-perspective space of the light, for the depth comparison.

Intuitively, the closer the approximation is to Area E, 302 the better the resolution of the resulting shadow map. The smallest such area is the convex hull C of area E, 302. However, it is not clear how to efficiently transform C (which is a polygon of up to six edges) to a shadow map (generally a rectangular shape) while minimising wastage.

The next natural choice is to use the smallest enclosing bounding box B 308 to approximate C for the purpose. However, a bounding box approximation may not always result in minimum wastage, as can be seen from a comparison of the bounding box space 310 with the trapezoidal space 304 in FIG. 3.

In the example embodiment, a trapezoid is recognised to be a suitable shape to approximate area E, 302. More importantly, its two parallel top and base edges 305, 307 form a surprisingly powerful mechanism to control the shape and the size of a trapezoid from frame to frame (as will be discussed later). This successfully addresses the continuity problem. Equally important and interesting for the choice of trapezoid in the example embodiment are its two side edges 309, 311 in addressing another kind of “implicit” wastage not mentioned in the above discussion. Such wastage is the over-sampling of near objects in the shadow map where a lower sampling rate would suffice. The example embodiment has an efficient mechanism to decide on the two side edges 309, 311 to spread the available resolution to objects within a specified focus region. In comparison, the transformation used in the smallest bounding box B 308 does not have such flexibility in stretching a shape. As a result, the smallest bounding box approach has a deteriorating effect on the shadow map resolution when the depth of view increases.

As mentioned, in the background section, the continuity problem is a consequence of a significant change in the shadow map quality from one frame to the next, resulting in flickering of shadows. For the smallest bounding box approach, the shadow map quality changes if there is a sudden change in the approximation of the area within the eye's frustum as seen from the light. FIG. 2(a) shows from frame i to frame i+1 that the orientation of the approximation of the area within the eye's frustum as seen from the light 202, 203 respectively with the smallest bounding box 204, 205 respectively is changed. As a result, there is a drastic change to the resolution in different parts of the shadow map. In general, the problem can often occur when the eye's frustum as seen from the light transits from one shape to another different shape (where the number of side planes of the eye's frustum as seen from the light visible from the light's view is different). In contrast, in the trapezoidal approach of the example embodiment, FIG. 2(b) shows from frame i to frame i+1 that no drastic change occurs to the resolution in different parts of the shadow map, compare shadows 218, 220.

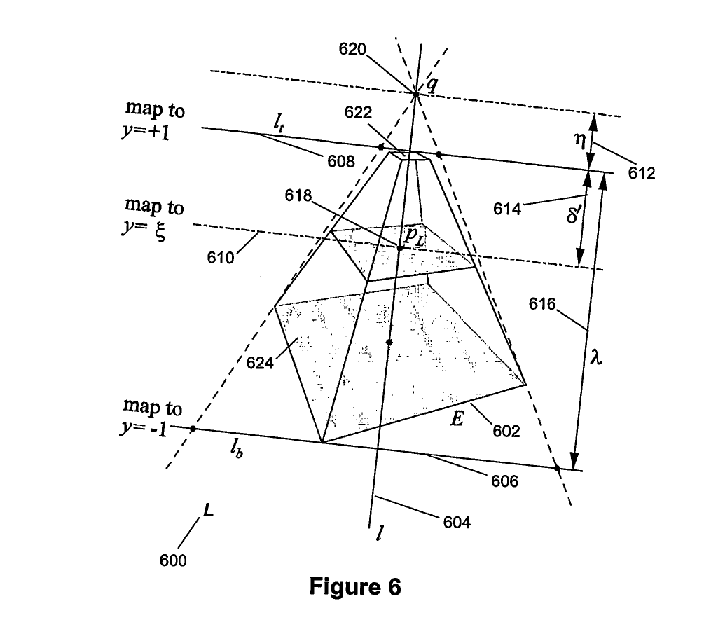

With reference to FIG. 6, the example embodiment has an efficient and effective way to control the changes in trapezoids to address the continuity problem.

The aim is to construct a trapezoid to approximate the area E, 602, within the eyes frustum as seen from the light with the constraint that each such consecutive approximation results in a smooth transition of the shadow map resolution. The strategy adopted in the example embodiment is to rely on a smooth transition in the shape and size of trapezoid to result in a smooth transition of the shadow map resolution. To begin with, the example embodiment makes computations to obtain the base and top line. From these, the base and top edge of the trapezoid are defined when the two side lines are computed.

The following describes the computation to obtain the base and top line of the trapezoidal boundary on E, 602.

The computation is done to find two parallel lines in the post-perspective space of the light L, 600, to contain the base and the top edges of the required trapezoid. The aim is to choose the parallel lines such that there is a smooth transition when the eye moves (relative to the light) from frame to frame.

First, the eye's frustum is transformed into the post-perspective space L 600 of the light to obtain E, 602.

Next, the centre line I 604, which passes through the centres of the near plane 622 and the far plane 624 of E 602 is computed.

Next, the 2D convex hull of E 602 (with at most six vertices on its boundary) is calculated.

Next, the top line Iₜ 608 that is orthogonal to I 604 and touches the boundary of the convex hull of E 602 is calculated. The top line Iₜ 608 intersects I 604 at a point closer to the centre of the near plane 622 than that of the far plane 624 of E 602.

Then, the base line I_{b} 606 which is parallel to (and different from) the top line Iₜ 608 (i.e., orthogonal to I too) and touches the boundary of the convex hull of E 602 is calculated.

The above algorithm is such that the centre line I 604 governs the choices of Iₜ 608 and I_{b} 606, with the exception for the case when the centres of the far and near planes (almost) are coincident. In the example embodiment, the algorithm handles that separately to result in the smallest box bounding the far plane 624 as the desired trapezoid. The next two paragraphs explain the rationale of the above algorithm to address the continuity problem.

Imagine E, 602, the eye's frustum is drawn within a sphere with the centre of the sphere at the eye's position and the radius equal to the distance from the eye to each corner of the far plane 624. Suppose the eye's location does not change. Pitching and heading of the eye from one frame to the next can be encoded as a point (which is the intersection of I 604 with the sphere) on the sphere to another nearby point, while rolling of the eye does not change the encoded point but results in a rotation of eye's frustum along I 604. More importantly, with a smooth eye motion from frame to frame, the four corners of the far plane 624 of the eye's frustum lying on the sphere also have a smooth transition on the sphere. As the positions of I 604 and the mentioned four corners uniquely determine I_{b} 606, it also transits smoothly from frame to frame. Similarly, Iₜ 608 transits smoothly from frame to frame, too.

Next, suppose the eye's location does change relative to the light from one frame to the next but maintains its orientation. In this case, it is only a matter of scaling E, 602, and the I_{b} 606 and Iₜ 608 computed are parallel to the previous ones. In other words, both I_{b} 606 and Iₜ 608 again transit smoothly from frame to frame under a smooth translation of the eye's frustum.

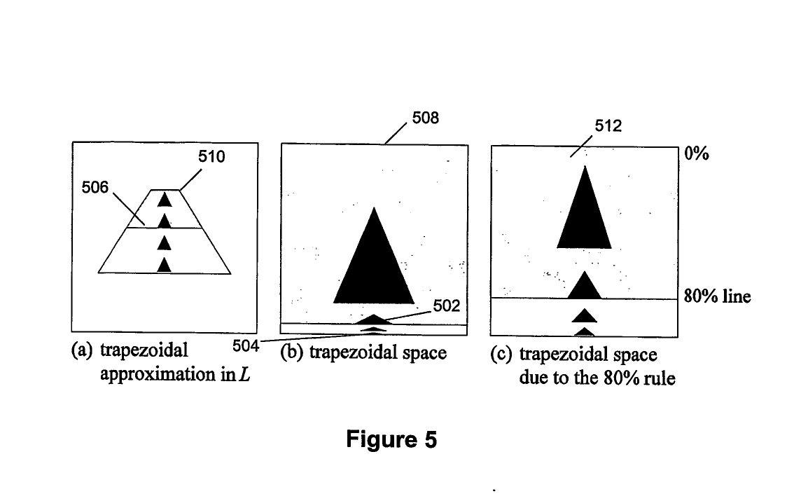

Before describing the computation of the side lines, we first analyse the effect of transforming a given trapezoid in FIG. 5(a) by its N_{T} to a trapezoidal space. Note that N_{T} has the effect of stretching the top edge into a unit length. In this case, the top edge is relatively short compared to the base edge, and therefore the stretching results in pushing all the shown triangles towards the bottom of the unit square as in FIG. 5(b). This means that the region near to the top edge bounded by Iₜ (608 in FIG. 6) (i.e., close to the near plane (622 in FIG. 6)) eventually occupies a major part of the shadow map. This results in an over-sampling in the shadow map for objects very near to the eye while sacrificing resolution of the other objects (such as the second triangle 502 to the fourth triangle 504 from the top in FIG. 5(b)). This is the kind of wastage due to over-sampling as mentioned above.

For the trapezoid 510 in FIG. 5(a), its corresponding trapezoidal space 508 is shown in FIG. 5(b). In the case of FIG. 5(b), we obtain an over-sampling for a small region of E 506. In the case of FIG. 5(c), for a different trapezoid computed with the 80% rule (having the same top and base lines), its trapezoidal transformation maps the focus region 512 (the upper part of the trapezoid) to within the first 80% in the shadow map.

Conversely, a small part of the shadow map is occupied by near objects when a “fat” trapezoid (having top and base edges of almost equal lengths) is transformed by its trapezoidal transformation. As the approach adopted by the example embodiment aims to achieve effective use of available shadow map memory by “important” objects in the eye's frustum, the algorithm to compute the side lines and thereafter compute the required trapezoid is as follows.

Next, the computation of the side lines, which will form the side edges of the trapezoidal boundary on E, 602, will be described.

With reference to FIG. 6, assume the eye is more interested in objects and their shadows within the distance δ from the near plane 622. That is, the region of focus, or simply the focus region, of the eye is the eye's frustum truncated at δ distance from the near plane 622. Let p be a point of δ distance away from the near plane 622 with its corresponding point p_{L} 618, lying on I, 604, in L, 600. Let the distance of p_{L}, 618, from the top line be δ′, 614. The example embodiment constructs a trapezoid to contain E, 602, so that N_{T} maps p_{L}, 618, to some point on the line of 80% or what is referred in the example embodiment as the 80% line in the trapezoidal space (see FIG. 5(c)). Such an approach is herein referred to as the 80% rule.

To do this, a perspective projection problem is formulated to compute the position of a point q, 620, on I, 604, with q, 620, as the centre of projection to map p_{L}, 618, to a point on the 80% line y=ξ 610 (i.e. ξ=−0.6), and the base line 606 and the top line 608 to y=−1 and y=+1, respectively. Let λ, 616, be the distance between the base and the top line. Then, the distance of q, 620, from the top line, denoted as η, 612, is computed through the following 1D homogenous perspective projection:

$$( \begin{matrix}\frac{- ( λ + 2 η )}{λ} & \frac{2 ( λ + η ) η}{λ} \\ 1 & 0\end{matrix} ) \cdot ( \begin{matrix}{δ}^{′} + η \\ 1\end{matrix} ) = ( \begin{matrix}\tilde{ξ} \\ ω\end{matrix} ) , and ξ = \frac{\tilde{ξ}}{ω} . \\ So , η = \frac{λ {δ}^{′} + λ {δ}^{′} ξ}{λ - 2 {δ}^{′} - λ ξ} .$$

Next, two lines passing through q, 620, and touching the convex hull of E, 602, are constructed to be the side lines containing the side edges of the required trapezoidal boundary.

For some situations (such as the eye's frustum as seen in the post-perspective space of the light is a dueling frusta case), the 80% rule may result in a significant wastage of shadow map memory. Hence, in the example embodiment, the above algorithm is modified to an iterative process. Suppose the shadow map is a map with x horizontal lines of entries. (Examples of values of x in some applications are 512, 1024 or 2048.) In the first iteration, p_{L} 618, is mapped to the 80% line (or 0.8x), and in each subsequent iteration, p_{L} 618, is mapped to an entry one line before that of the last iteration to compute q, 620. With each computed q, 620, a corresponding trapezoid and its trapezoidal transformation N_{T} are computed as before. From all the iterations, the trapezoid, with its N_{T} that transforms the focus region to cover the largest area (though other metrics are possible) in the shadow map, is adopted. In another embodiment, the iterations can stop once the value of x can be located where the focus region covers a local maximum largest area (or other corresponding metrics) in the shadow map. In other words, the iteration can stop once there is a change from a good coverage to a bad coverage, and use the good coverage to be the value of x. The above computation is not expensive as it involves simple arithmetic and only a small number of iterations. In fact, for a given up vector of the eye and a given angle between the eye's and the light's line of sight, the best ξ, 610, to where p_{L}, 618, is mapped is independent of the scene and can thus be pre-computed. Therefore, all these best ξ, 610, (and thus η, 612) can be stored in a table with the parameter of the angle between the eye's and the light's line of sight, for each possible up vector of the eye. Thus, in another embodiment, a simple table lookup can also replace the above iterative process.

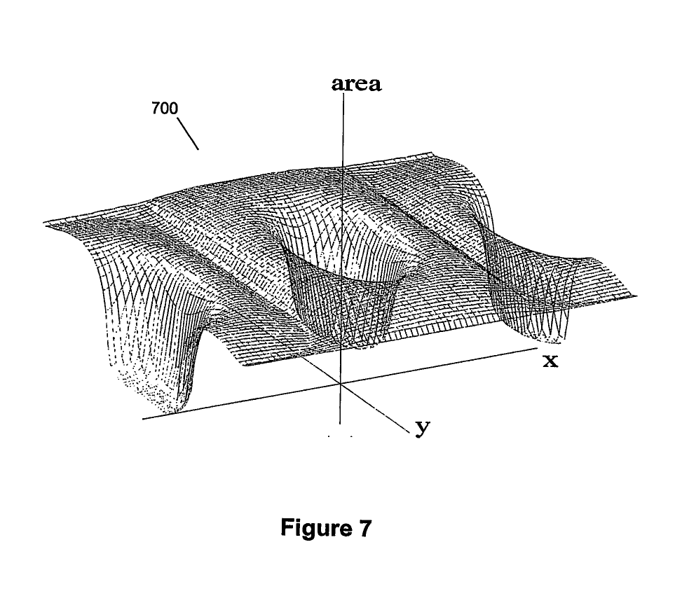

FIG. 7 shows a plot 700 of the areas occupied by the focus regions in the shadow map with a constant up vector of the eye while varying the angle between the eye's and the light's line of sight. The focus regions occupy small areas for the dueling frusta case, but large area when, for example, one side face of E is visible in the light's view.

To understand the 80% rule, the plot 700 of the total area covered by the focus region in the shadow map is generated by varying the angle (represented as a data point on the xy-plane) between the eye's and the light's line of sight while keeping the up vector constant. Experiments were done with a series of the same kind of plots with different up vectors. It was observed that consecutive plots of slightly different up vectors are surfaces of very close values. These plots indicate that there is a smooth transition on the area occupied by the focus region. This is a strong indication that the approach adopted by the example embodiment addresses the continuity problem well. Therefore, the 80% rule utilised in the example embodiment is effective. In another embodiment, one can adjust this percentage according to the need of the application.

The above discussion assumes that the eye's frustum lies completely within the lights frustum, such as in an outdoor scene where the sun is the main light source. If this is not the case, one adaptation is to enlarge the light's view to include the eye's frustum. This is not an effective use of the shadow map. Also, this can be delicate to handle and may not always be feasible. There are also situations where the vertices of the eye's frustum lie behind or on the plane passing through the centre of projection of the light and parallel to the near plane of the light. Such vertices have inverted order or are mapped to infinity in L (600 in FIG. 6). The next two paragraphs discuss a simple extension which avoids such situations.

Specifically, it suffices to only transform the portion of the eye's frustum that is inside the light's frustum to L (600 in FIG. 6). The remaining portion, which is not inside the light's frustum, is clearly not illuminated and hence cannot have shadows. Therefore, in the example embodiment, only the intersection I between the light's frustum and the eye's frustum (with no more than 16 intersections as its vertices) are processed. This conveniently avoids the above problem due to the perspective transformation.

The line I (604 in FIG. 6) passing through the centres of near and the far plane of the eye's frustum may no longer be the centre line for the computation of the base and top line. One approach is to compute the centre point e of the vertices of I, and use the line passing through the position of the eye and e to be the new centre line Iₙ for the computation. A new focus region has to be defined, because the focus region may not be completely within I. One approach is to geometrically push the near plane (622 in FIG. 6) and far plane (624 in FIG. 6) of the eye (closer to each other) to tightly bound I in the world space to obtain f′ as the distance between those planes. Let f be the distance between the original far and near planes of the eye in the world space. Then, in one embodiment, the new focus region lies within the new near plane and its parallel plane, where the distance between the planes is (δf′/f. Note that δ is the distance originally chosen to set the focus region.

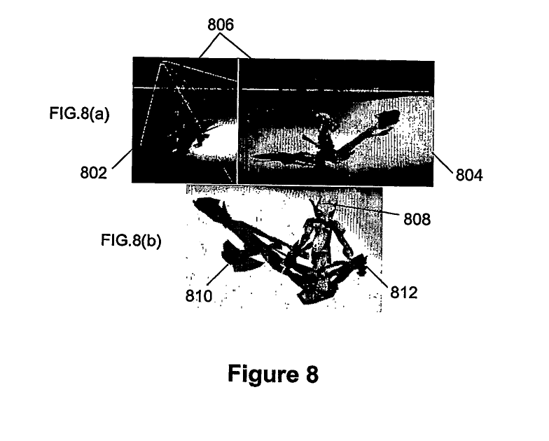

With the above, the approach adopted in an example embodiment is now suited for a wider range of applications: near to far lights, and both indoor and outdoor scenes. FIGS. 8(a) and (b) shows the displays of such cases with two lights illuminating a fantasy character. FIG. 8(a) shows the character 806 lit by one nearby light 802 and two nearby lights 804 while viewed from outside the lights' frusta. FIG. 8(b) shows the character 808 lit by a close light (left shadow 810) and a far light (right shadow 812) rendered by the trapezoidal approximation approach adopted by the example embodiment. From FIG. 8, it can be observed that the approach adopted in the example embodiment can achieve high shadow quality for the close light situation as well as for the transition to the far light situation, which is unfavourable to the standard shadow map.

The following description formalises the use of trapezoidal approximation in the approach adopted in the example embodiment.

Refer to FIG. 3. Consider a vertex v in the object space. Then, that vertex in the post-perspective space of the light L, 300 is v_{L}=P_{L}·C_{L}·W·v where P_{L} and C_{L} are the projection and camera matrices of the light and W is the world matrix of the vertex. The eight corner vertices of E, 302, in L, 300, are obtained from the corner vertices of E, 302 in the object space multiplied by P_{L}·C_{L}·C_{E}⁻¹ where C_{E}⁻¹ is the inverse camera matrix of the eye. As illustrated in FIG. 4, E, is treated as a flattened two Dimensional (2D) object on the front face 400 of the light's unit cube 404. We use a trapezoid T 402, to approximate (and contain) E treated as the 2D object. A normalisation matrix N_{T} is constructed such that the four corners of T, 402, are mapped to the unit square 401 or a rectangle. We call v_{T}=N_{T}·v_{L} a vertex in the trapezoidal space, N_{T} a trapezoidal transformation matrix, and the shadow map derived from the trapezoidal space a trapezoidal shadow map.

The following describes the calculation of the trapezoidal transformation matrix N_{T} in the example embodiment to map the four corners of T to a unit square. Analogously, one can calculate N_{T} to map the four corners of T to a rectangle.

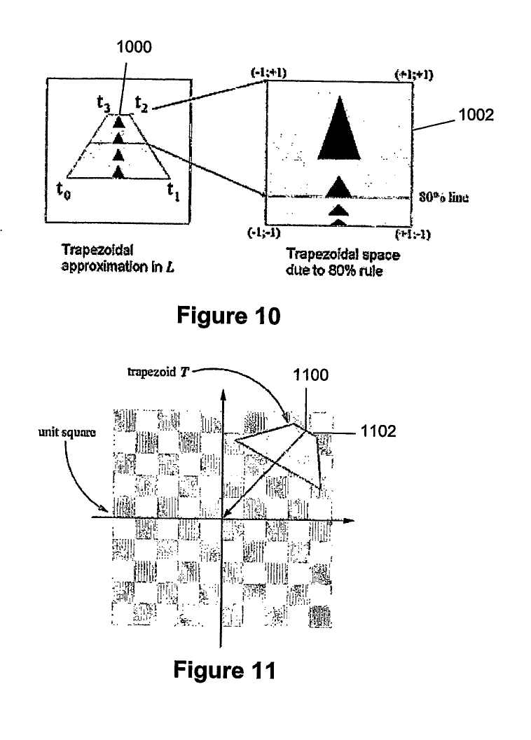

With reference to FIG. 10, the aim is to calculate a transformation N_{T} (4×4 matrix) which maps the four corners of the trapezoid 1000, t₀, t₁, t₂, and t₃ to the front side of the unit cube 1002, i.e. to calculate N_{T} with the following constraints:

$$( \begin{matrix}- 1 \\ - 1 \\ 1 \\ 1\end{matrix} ) = {N}_{T} \cdot {t}_{0} , ( \begin{matrix}+ 1 \\ - 1 \\ 1 \\ 1\end{matrix} ) = {N}_{T} \cdot {t}_{1} , ( \begin{matrix}+ 1 \\ + 1 \\ 1 \\ 1\end{matrix} ) = {N}_{T} \cdot {t}_{2} , and \\ ( \begin{matrix}- 1 \\ + 1 \\ 1 \\ 1\end{matrix} ) = {N}_{T} \cdot {t}_{3}$$

There are a few ways to achieve this. A general approach is to calculate using quadrilateral to quad mapping. Another way is to apply rotation, translation, shearing, scaling, and normalisation operations to the trapezoid to map it to the front side of the unit cube. The following illustrates a way to compute N_{T} from a series of 4×4 matrices T₁, R, T₂, H, S₁, N₁ T₃ and S₂. In the following discussion, the vectors u=(xᵤ, yᵤ, zᵤ, wᵤ) and v=(xᵥ, yᵥ, zᵥ, wᵥ) hold intermediate results.

As a first step, with reference to FIG. 11, T₁ transforms the centre 1100 of the top edge 1102 to the origin:

$$u = \frac{{t}_{2} + {t}_{3}}{2} , and {T}_{1} = ( \begin{matrix}1 & 0 & 0 & - {x}_{u} \\ 0 & 1 & 0 & - {y}_{u} \\ 0 & 0 & 1 & 0 \\ 0 & 0 & 0 & 1\end{matrix} ) .$$

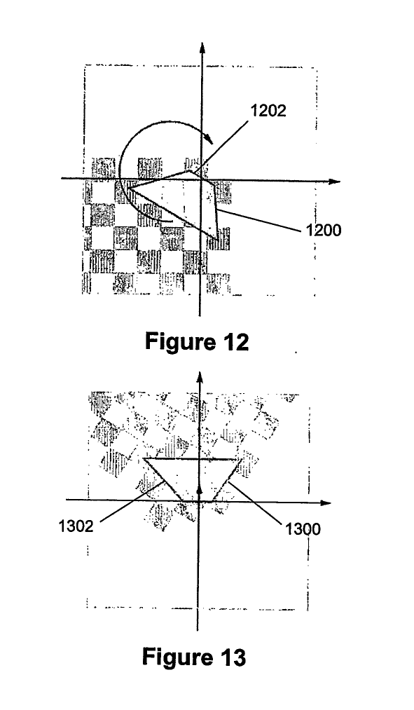

Then, with reference to FIG. 12, the trapezoid T 1200 is rotated by applying R around the origin in such a way that the top edge 1202 is collinear with the x-axis:

$$u = \frac{{t}_{2} - {t}_{3}}{\vert {t}_{2} - {t}_{3} \vert} , and R = ( \begin{matrix}{x}_{u} & {y}_{u} & 0 & 0 \\ {y}_{u} & - {x}_{u} & 0 & 0 \\ 0 & 0 & 1 & 0 \\ 0 & 0 & 0 & 1\end{matrix} ) .$$

Next, with reference to FIG. 13, the intersection i of the two side lines 1300, 1302 containing the two side edges (t₀, t₃) and (t₁, t₂) is transformed, by applying T₂, to the origin:

$$u = R \cdot {T}_{1} \cdot i , and {T}_{2} = ( \begin{matrix}1 & 0 & 0 & - {x}_{u} \\ 0 & 1 & 0 & - {y}_{u} \\ 0 & 0 & 1 & 0 \\ 0 & 0 & 0 & 1\end{matrix} ) .$$

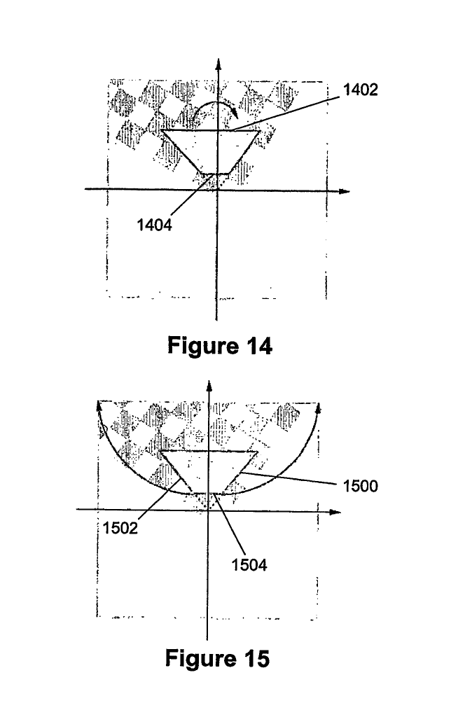

As a next step, with reference to FIG. 14, the trapezoid has to be sheared with H, so that it is symmetrical to the y-axis, i.e. that the line passing through the centre of the bottom edge 1402 and centre of the top edge 1404 is collinear with the y-axis:

$$u = \frac{{T}_{2} \cdot R \cdot {T}_{1} \cdot ( {t}_{2} + {t}_{3} )}{2} , and H = ( \begin{matrix}1 & - {x}_{u} / {y}_{u} & 0 & 0 \\ 0 & 1 & 0 & 0 \\ 0 & 0 & 1 & 0 \\ 0 & 0 & 0 & 1\end{matrix} ) .$$

Next, with reference to FIG. 15, the trapezoid is scaled by applying S₁, so that the angle between the two side lines 1500, 1502 containing the two side edges (t₀, t₃) and (t₁, t₂) is 90 degrees, and so that the distance between the top edge 1504 and the x-axis is 1:

$$u = H \cdot {T}_{2} \cdot R \cdot {T}_{1} \cdot {t}_{2} , and {S}_{1} = ( \begin{matrix}1 / {x}_{u} & 0 & 0 & 0 \\ 0 & 1 / {y}_{u} & 0 & 0 \\ 0 & 0 & 1 & 0 \\ 0 & 0 & 0 & 1\end{matrix} ) .$$

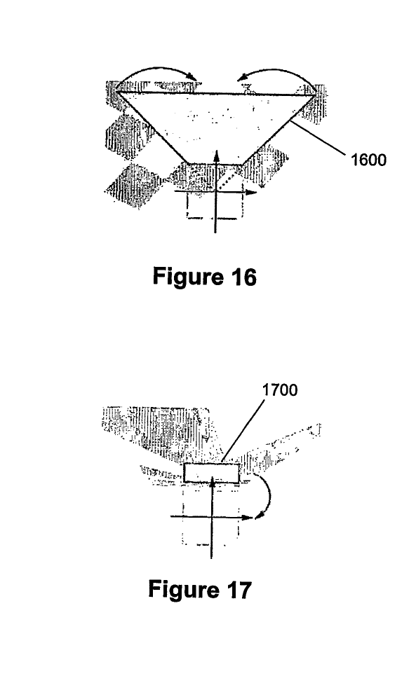

Next, with reference to FIG. 16, the following transformation N transforms the trapezoid to a rectangle 1600:

$$N = ( \begin{matrix}1 & 0 & 0 & 0 \\ 0 & 1 & 0 & 1 \\ 0 & 0 & 1 & 0 \\ 0 & 1 & 0 & 0\end{matrix} ) .$$

Then, with reference to FIG. 17, the rectangle 1700 is translated along the y-axis until its centre is coincident with the origin. This is done by applying T₃. After this transformation the rectangle 1700 is symmetrical to the x-axis as well:

$$u = N \cdot {S}_{1} \cdot H \cdot {T}_{2} \cdot R \cdot {T}_{1} \cdot {t}_{0} , \\ v = N \cdot {S}_{1} \cdot H \cdot {T}_{2} \cdot R \cdot {T}_{1} \cdot {t}_{2} , and$$

$${T}_{3} = ( \begin{matrix}1 & 0 & 0 & 0 \\ 0 & 1 & 0 & \frac{- ( {y}_{u} / {w}_{u} + {y}_{v} / {w}_{v} )}{2} \\ 0 & 0 & 1 & 0 \\ 0 & 0 & 0 & 1\end{matrix} ) .$$

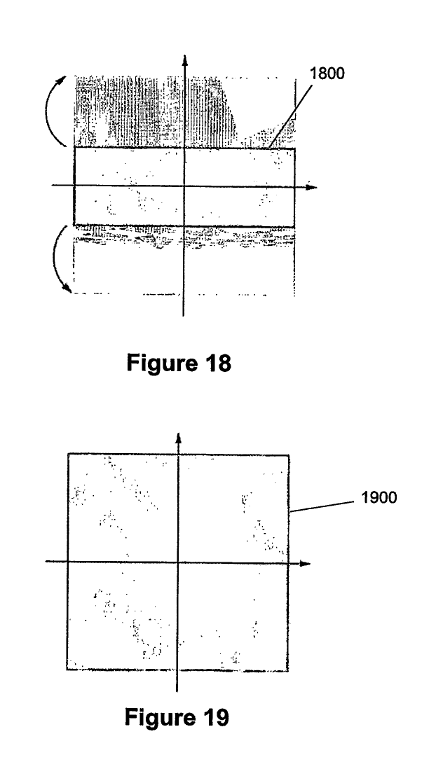

Then, with reference to FIG. 18, the rectangle 1800 has to be scaled with S₂ along the y-axis so that it covers the front side of the unit cube 1900, as shown in FIG. 19:

$$u = {T}_{3} \cdot N \cdot {S}_{1} \cdot H \cdot {T}_{2} \cdot R \cdot {T}_{1} \cdot {t}_{0} , and {S}_{2} = ( \begin{matrix}1 & 0 & 0 & 0 \\ 0 & - {w}_{u} / {y}_{u} & 0 & 0 \\ 0 & 0 & 1 & 0 \\ 0 & 0 & 0 & 1\end{matrix} ) .$$

Thus, the trapezoidal transformation N_{T} can be computed as follows:
N_{T}=S₂·T₃·N·S₁·H·T₂·R·T₁.

Returning to FIG. 4, in the example embodiment, the intent of N_{T} is to transform only the x and y values of those vertices of objects. This transformation, however, also affects the z value of each vertex depending on its x and y values. Thus, a single offset for all vertices (as in the standard shadow map approach) may not be adequate to remedy surface acne effects.

FIG. 4 shows the trapezoidal approximation 402 of the eye's frustum within the light's frustum in the post-perspective space of the light. FIG. 4 also shows the trapezoidal approximation under the trapezoidal transformation described above resulting in a unit square 401 (or rectangle) for the front view 405 but a trapezoid on the side view 409. This worsens the polygon offset problem. FIG. 4 also shows an approach adopted by the example embodiment to maintain a unit square 407 for the side view 408 under the trapezoidal transformation.

The trapezoidal transformation incorporates a two-dimensional projection. An important property of this transformation is that the z_{T} of the vertex in trapezoidal space depends on the w_{T}. In actual fact, the distribution of the z-values is changing over the trapezoidal shadow map so that a constant polygon offset as in the standard shadow map approach may not be adequate. The problem is that the specified polygon offset might be too high for pixels containing object near to the eye or might be too low for pixels containing object further away. If the polygon offset is too high it can happen that shadows are disappearing; on the other hand, if it is too low surface acne might be introduced.

By maintaining the depth value in the post-perspective space of the light in the example embodiment, a constant polygon offset may be specified similar to the technique used in the standard shadow map approach to combat the polygon offset problem. The distribution remains uniform, as can be seen from the unit square 407 from the side view 408 in FIG. 4.

In one embodiment, to achieve this only the x, y and w values of each vertex are transformed by N_{T} to the trapezoidal space (304 in FIG. 3), while maintaining the z value in the post-perspective space L (300 in FIG. 3) of the light. In a simple form, the formula to transform a vertex to the trapezoidal space (304 in FIG. 3) is now done as in v_{T}=N_{T}v_{L} to get its x_{T}, y_{T} and w_{T} values, and then compute the z_{T} value from the z and w values of v_{L}, i.e. z_{L} and w_{L}, as:

$${z}_{T} = \frac{{z}_{L} \cdot {w}_{T}}{{w}_{L}} .$$

The above calculation can be implemented with a vertex program to compute the required z_{T} during the first pass of shadow map generation, and another vertex program to compute the corresponding z_{T} in L (300 in FIG. 3) for each vertex during the second pass of shadow determination. This embodiment is easy to implement and practically workable. However, such an approach is only an approximation to the actual z values. When the eye or light frustums contain no particularly large triangles, such incorrect z value at each point of a triangle was found not to matter, as the error is small and thus negligible once it is adjusted with a relatively large polygon offset.

To improve on the above embodiment, other embodiments may utilise approaches based on ray casting, and/or based on multiple texture coordinates. Note that each approach has the usual two passes of the shadow map generation and the shadow determination. One can combine these approaches into four different combinations of methods to address the problem.

In the ray casting approach, the fragment stage is used to compute the correct z value for each fragment in L (300 in FIG. 3). In the first pass (shadow map generation), N_{T}⁻¹ and the inverse viewport matrix to transform the x and y values of a fragment from the trapezoidal space back to L (300 in FIG. 3) are used. After that, a plane equation π in L (300 in FIG. 3) of the fragment is used to compute the z value. This value is added with an offset and then stored into the shadow map. Then, in the second pass (shadow determination), N_{T}⁻¹ is applied to the x_{T}, y_{T} and w_{T} values of the texture coordinate assigned to the fragment (through projective texturing) to obtain x_{L}, y_{L} and w_{L}. With these values, the z value of the fragment in L (300 in FIG. 3) is computed from π. This z value is to compare with the depth value stored in the (x_{T}/w_{T}, y_{T}/w_{T})-entry of the shadow map to determine whether the fragment is in shadow.

In the multiple texture coordinates approach, at the first pass (shadow map generation), the vertex stage transforms each vertex v to v_{T}=(x_{T}, y_{T}, z_{T}, w_{T}) and assigns v_{L}=(x_{L}, y_{L}, z_{L}, w_{L}) as its texture coordinate. The texture coordinates over a triangle are obtained by linearly interpolating the v_{L}/w_{T} values of the vertices of the triangle. Next, the fragment stage replaces the depth of the fragment with z_{L}/w_{L} and adds to it an offset. In effect, the z value of the vertex in the trapezoidal space is set as zₗ with the necessary polygon offset. In the second pass (shadow determination), the vertex stage transforms each vertex to the post-perspective space of the eye as the output vertex. It also computes, for the vertex, two texture coordinates v_{L}=(x_{L}, y_{L}, z_{L}, w_{L}) and v_{T}=(x_{T}, y_{T}, z_{T}, w_{T}). Then, the fragment stage processes each fragment to determine shadow by comparing z_{L}/w_{L} to the value in the shadow map indexed by (x_{T}/w_{T}, y_{T}/w_{T}).

Annexure A shows vertex and fragment program codes for implementing the trapezoidal transformation in an example embodiment. The approach adopted is the multiple texture coordinates approach described above. Only the shadow map generation step is shown, i.e. the first pass of the algorithm, because the second pass of the algorithm works in a similar way. The same functionality as in Annexure A can be achieved with, for example, other version of vertex and fragment programs or Cg or other computer graphic programs.

Note that for the sake of clarity, the calculation of a constant polygon offset, which is added to the final depth value is omitted in Annexure A.

Annexure B shows a display routine for use in an implementation of the described algorithm in an example embodiment.

The example embodiment may be implemented using GNU C++ and OpenGL under Linux environment on an Intel Pentium 4 1.8 GHz CPU with a nVidia GeForce FX5900 ultra graphics controller. ARB vertex/fragment programs or Cg programs may be used to address the polygon offset problem. The shadow maps may be rendered into a pbuffer or general texture memory. The example embodiment uses various geometric yet simple operations such as convex hulls, line operations etc. in 2D, thus making robustness issues easy to handle.

Embodiments of the present invention may provide the following advantages.

Shadow map resolution is improved by approximating the eye's frustum seen by the light with a trapezoid and warping the trapezoid onto a shadow map. This increases the number of samples for areas closer to the eye and therefore results in higher shadow quality.

The trapezoid is calculated such that a smooth change in shadow map resolution is achieved. The calculation is not computationally expensive as the trapezoid is only calculated based on the eight vertices of the eye's frustum rather than on the whole scene which eliminates the continuity problem occurring in all prior art.

Furthermore, the trapezoidal approximation is a constant operation and the algorithm scales well. No doubt the warp contains a perspective transformation, where polygon offset becomes an issue. However, this problem can be resolved by one of the three approaches discussed in the example embodiment where utilisation of the vertex/fragment programs or Cg programs on modern graphics hardware is involved.

It is appreciated that a person skilled in the art can easily apply the present invention utilising multiple light sources with a shadow map for each light source.

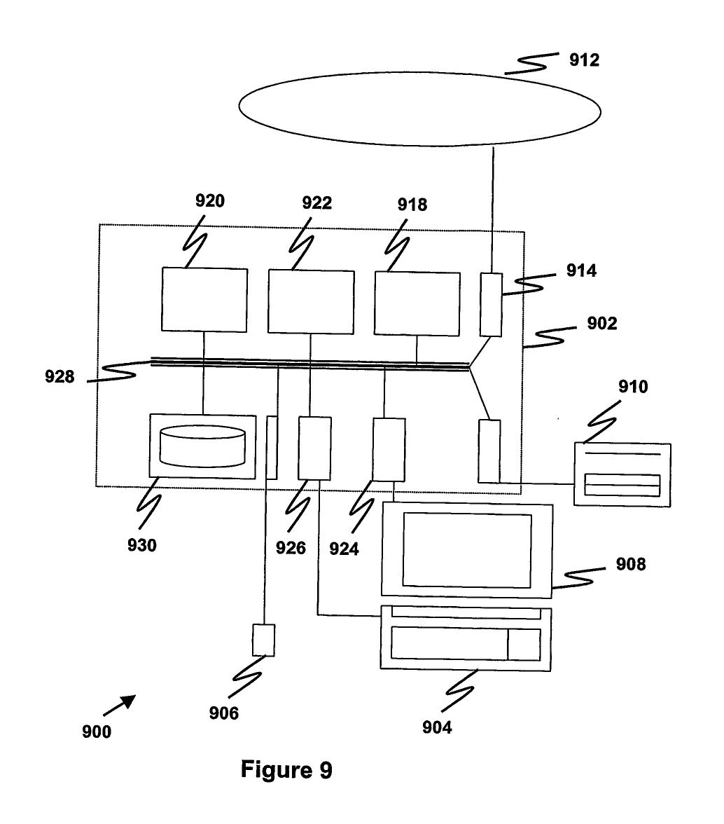

The method and system of the example embodiment can be implemented on a computer system 900, schematically shown in FIG. 9. It may be implemented as software, such as a computer program being executed within the computer system (which can be a palmtop, mobile phone, desktop computer, laptop or the like) 900, and instructing the computer system 900 to conduct the method of the example embodiment.

The computer system 900 comprises a computer module 902, input modules such as a keyboard 904 and mouse 906 and a plurality of output devices such as a display 908, and printer 910.

The computer module 902 is connected to a computer network 912 via a suitable transceiver device 914, to enable access to e.g. the Internet or other network systems such as Local Area Network (LAN) or Wide Area Network (WAN).

The computer module 902 in the example includes a processor 918, a Random Access Memory (RAM) 920 and a Read Only Memory (ROM) 922. The computer module 902 also includes a number of Input/Output (I/O) interfaces, for example I/O interface 924 to the display 908 (or where the display is located at a remote location), and I/O interface 926 to the keyboard 904.

The components of the computer module 902 typically communicate via an interconnected bus 928 and in a manner known to the person skilled in the relevant art.

The application program is typically supplied to the user of the computer system 900 encoded on a data storage medium such as a CD-ROM or floppy disk and read utilising a corresponding data storage medium drive of a data storage device 930. The application program is read and controlled in its execution by the processor 918. Intermediate storage of program data maybe accomplished using RAM 920.

In the foregoing manner, a method for generating shadows utilising trapezoidal shadow maps is disclosed. Only several embodiments are described. However, it will be apparent to one skilled in the art in view of this disclosure that numerous changes and/or modifications may be made without departing from the scope of the invention.

1. A method of real-time shadow generation in computer graphical representation of a scene, the method comprising
defining an eye's frustum based on a desired view of the scene;
defining a location of a light source illuminating at least a portion of the scene;
generating a trapezoid to approximate an area, E, within the eye's frustum in the post-perspective space of the light, L;
applying a trapezoidal transformation to objects within the trapezoid into a trapezoidal space for computing a shadow map; and
determining whether an object or part thereof is in shadow in the desired view of the scene utilising the computed shadow map.

2. The method as claimed in claim 1, wherein generating the top and base lines lₜ and l_{b} respectively, of the trapezoid to approximate E in L, comprises
computing a centre line l, which passes through centres of the near and far planes of E;
calculating the 2D convex hull of E;
calculating lₜ that is orthogonal to l and touches the boundary of the convex hull of E;
calculating l_{b} which is parallel to lₜ and touches the boundary of the convex hull of E.

3. The method as claimed in claim 1, wherein, in the case that the centres of the far and near planes of E are substantially coincident, a smallest box bounding the far plane is defined as the trapezoid.

4. The method as claimed in claim 1, wherein generating the side lines of the trapezoid to approximate E in L comprises
assigning a distance δ from the near plane of the eye's frustum to define a focus region in the desired view of the scene;
determining a point p_{L} in L that lies on l at the distance δ from the near plane of the eye's frustum;
computing the position of a point q on l, wherein q is the centre of a projection to map the base line and the top line of the trapezoid to y=−1 and y=+1 respectively, and to map p_{L} to a point on y=ξ, with ξ between −1 and +1; and
constructing two side lines of the trapezoid each passing through q, wherein each sideline touches the 2D convex hull of E on respective sides of l.

5. The method as claimed in claim 4, wherein ξ=−0.6.

6. The method as claimed in claim 4, wherein the desired point ξ is determined based on an iterative process that minimizes wastage.

7. The method as claimed in claim 6, wherein the iterative process is stopped when a local minimum is found.

8. The method as claimed in claim 6, wherein the iterative process is pre-computed and the results stored in a table for direct reference.

9. The method as claimed in claim 1, comprising
determining an intersection I, between the light source's frustum and the eye's frustum;
computing the centre point e of the vertices of I;
defining a centre line lₙ passing through the position of the eye and e, for generating the trapezoid.

10. The method as claimed in claim 9, further comprising defining a new focus region which lies between the near and far planes of the eye's frustum that are geometrically pushed closer to tightly bound I.

11. The method as claimed in claim 1, wherein the trapezoidal transformation comprises mapping the four corners of the trapezoid to a unit square that is the shape of a square shadow map, or to a general rectangle that is the shape of a rectangular shadow map.

12. The method as claimed in claim 11, wherein the size of the square or general rectangle changes based on a configuration of the light source and the eye.

13. The method as claimed in claim 1, wherein the trapezoidal transformation transforms only the x and the y values of a vertex from the post-perspective space of the light to the trapezoidal space, while the z value is maintained at the value in the post-perspective space of the light.

14. The method as claimed in claim 13, comprising applying the trapezoidal transformation to obtain the x, y, and w values in the trapezoidal space, x_{T}, y_{T}, and w_{T}, and computing the z value in the trapezoidal space, z_{T}, as
$${z}_{T} = \frac{{z}_{L} \cdot {w}_{T}}{{w}_{L}} . ,$$
where z_{L} and w_{L}, are the z and w values in the post-perspective space of the light, respectively.

15. The method as claimed in claim 13, comprising:
in a first pass of shadow map generation,
transforming coordinate values of a fragment from the trapezoidal space back into the post-perspective space L of the light to obtain a first transformed fragment, utilising the plane equation of the first transformed fragment to compute a distance value of the first transformed fragment from the light source in L, z_{L1}, adding an offset value to z_{L1}, and store the resulting value as a depth value in the shadow map;
in a second pass of shadow determination,
transforming texture coordinate assigned, through projective texturing, to the fragment from the trapezoidal space back into L, obtaining a second transformed fragment from the transformed texture coordinate, utilising the plane equation of the second transformed fragment to compute a distance value of the second transformed fragment from the light source in L, z_{L2}, and determine whether the fragment is in shadow based on a comparison of the stored depth value in the shadow map and z_{L2}.

16. The method as claimed in claims 13 comprising
in a first pass of shadow map generation,
during a vertex stage, transforming coordinate values of the vertex into the trapezoidal space, and assigning to the vertex the texture coordinate equal to the vertex's coordinate values in the post-perspective space of the light, and
during a fragment stage, replacing the depth of the fragment with the texture coordinate of the fragment, adding to the depth an offset, and store the resulting value as a depth value in the shadow map;
in a second pass of shadow determination,
during the vertex stage, transforming coordinate values of the vertex into the post-perspective space of the eye, and assigning to the vertex two texture coordinates that are first the coordinate values of the vertex in the post-perspective space of the light and second the coordinate values of the vertex in the trapezoidal space, and
during the fragment stage, determining shadow of the fragment based on a comparison of the stored depth value in the shadow map, as indexed based on the second texture coordinate of the fragment, with a value based on the first texture coordinate of the fragment.

17. The method as claimed in claim 13 comprising
in a first pass of shadow map generation,
transforming coordinate values of a fragment from the trapezoidal space back into the post-perspective space L of the light to obtain a first transformed fragment, utilising the plane equation of the first transformed fragment to compute a distance value of the first transformed fragment from the light source in L, z_{L1}, adding an offset value to z_{L1}, and store the resulting value as a depth value in the shadow map,
in a second pass of shadow determination,
during the vertex stage, transforming coordinate values of the vertex into the post-perspective space of the eye, and assigning to the vertex two texture coordinates that are first the coordinate values of the vertex in the post-perspective space of the light and second the coordinate values of the vertex in the trapezoidal space, and
during the fragment stage, determining shadow of the fragment based on a comparison of the stored depth value in the shadow map, as indexed based on the second texture coordinate of the fragment, with a value based on the first texture coordinate of the fragment.

18. The method as claimed in claim 13 comprising
in a first pass of shadow map generation,
during a vertex stage, transforming coordinate values of the vertex into the trapezoidal space, and assigning to the vertex the texture coordinate equal to the vertex's coordinate values in the post-perspective space of the light, and
during a fragment stage, replacing the depth of the fragment with the texture coordinate of the fragment, adding to the depth an offset, and store the resulting value as a depth value in the shadow map;
in a second pass of shadow determination,
transforming texture coordinate assigned, through projective texturing, to the fragment from the trapezoidal space back into L, obtaining a second transformed fragment from the transformed texture coordinate, utilising the plane equation of the second transformed fragment to compute a distance value of the second transformed fragment from the light source in L, z_{L2}, and determine whether the fragment is in shadow based on a comparison of the stored depth value in the shadow map and z_{L2}.

19. The method as claimed in claim 1, further comprising adding a polygon offset in the determining whether an object or part thereof is in shadow in the desired view of the scene for representation utilising the computed shadow map.

20. The method as claimed in claim 1, wherein two or more light sources illuminate at least respective portions of the scene, and the method is applied for each light source.

21. A system for real-time shadow generation in computer graphical representation of a scene, the system comprising
a processor unit for defining an eye's frustum based on a desired view of the scene; for defining a location of a light source illuminating at least a portion of the scene; for generating a trapezoid to approximate an area, E, within the eye's frustum in the post-perspective space of the light, L, from the light source; for applying a trapezoidal transformation to objects within the trapezoid into a trapezoidal space, for computing a shadow map; and for determining whether an object or part thereof is in shadow in the desired view of the scene utilising the computed shadow map.

22. A data storage medium having stored thereon computer code means for instructing a computer to execute a method of real-time shadow generation in computer graphical representation of a scene, the method comprising
defining an eye's frustum based on a desired view of the scene;
defining a location of a light source illuminating at least a portion of the scene;
generating a trapezoid to approximate an area, E, within the eye's frustum in the post-perspective space of the light, L, from the light source;
applying a trapezoidal transformation to objects within the trapezoid into a trapezoidal space for computing a shadow map; and
determining whether an object or part thereof is in shadow in the desired view of the scene utilising the computed shadow map
